(19) United States
(12) Patent Application Publication
(10) Pub. No.: US 2026/0351909 A1
(43) Pub. Date: Nov. 5, 2026

(54) CONNECTOR ASSEMBLY AND RADIO FREQUENCY CONNECTOR

(71) Applicant: Changzhou Jetty Automotive Parts Corporation, Changzhou (CN)

(72) Inventor: Chao WANG, Changzhou (CN)

(21) Appl. No.: 19/123,685

(22) PCT Filed: Oct. 31, 2023
(86) PCT No.: PCT/CN2023/128734

§ 371 Date: Apr. 23, 2025

(30) Foreign Application Priority Data
Oct. 31, 2022 (CN) 202222867984.6

(51) Int. Cl. H01R 24/40; H01R 103/00

(52) U.S. Cl. CPC H01R 24/40; H01R 2103/00

(57) ABSTRACT

Disclosed in the present disclosure is a connector assembly, including: an inner conductor, an insulator, an outer conductor and a metal ring, and the outer conductor is disposed around the inner conductor, the insulator is disposed between the inner conductor and the outer conductor, and the metal ring is disposed around at least a portion of an outer periphery of the insulator and is electrically connected to the outer conductor. The structure of the present disclosure enables impedance matching within a Radio Frequency (RF) connector; when the internal structure of the RF connector changes, the impedance of the connector can be adjusted by means of changing the metal ring, so as to prevent the variation of the outer conductor.

### RELATED APPLICATION

The present disclosure claims priority to Chinese Utility Model Patent Application NO. 202222867984.6 filed on Oct. 31, 2022, which is hereby incorporated by reference in its entirety.

### TECHNICAL FIELD

The present disclosure relates to the technical field of the communication, and particularly to a connector assembly and a Radio Frequency (RF) connector.

### BACKGROUND

In the field of Radio Frequency (RF) connectors, in order to ensure the complete transmission of RF signals, first of all, it should consider ensuring impedance matching within the RF connector. An RF connector is generally composed of three components including an outer conductor, an inner conductor and an inner insulator, along with other functional components, but it is ensured that the impedance matching is generally achieved through the coordinated design of these three components including the outer conductor, the inner conductor and the inner insulator. In the traditional RF connector design, the outer conductor is usually manufactured through a machining process. In this case, various structures such as steps, diameter changes, etc. are machined inside the outer conductor to achieve the impedance matching of the whole connector. However, with increasing cost pressures in the RF connector industry, more and more outer conductors are manufactured through a stamping process. In this case, when it is necessary to manufacture the structures such as the steps, the diameter changes, etc. inside the outer conductor to ensure the impedance matching, it will undoubtedly bring great difficulty to the technological process and have a high cost, and also increase the difficulty and the complexity of the design and the manufacturing of stamping dies. Therefore, a simple and easy-to-implement structure is required to achieve and maintain the impedance matching of the RF connector.

### SUMMARY

The present disclosure provides a connector assembly, including: an inner conductor, an insulator, an outer conductor and a metal ring, and the outer conductor is disposed around the inner conductor, the insulator is disposed between the inner conductor and the outer conductor, and the metal ring is disposed around at least a portion of an outer periphery of the insulator and is electrically connected to the outer conductor.

The present disclosure further discloses a Radio Frequency (RF) connector, including a connector housing and the aforementioned connector assembly, and at least a portion of the connector assembly is disposed in the connector housing, the connector housing is internally provided with a locking groove, and a fixing portion is matched with and connected to the locking groove to fix the connector assembly in the connector housing.

The structure of the present disclosure can realize impedance matching within an RF connector; when the internal structure of the RF connector changes, the impedance of the connector can be adjusted by means of changing the metal ring, so as to prevent the variation of the outer conductor, thereby realizing the universality of the outer conductor; meanwhile, the outer conductor manufactured through stamping is prevented from having excessive steps and diameter changes, thereby reducing the process difficulty and the die complexity, and facilitating a reduction in costs.

Other features and advantages of the present disclosure will become clear from the following detailed description of the exemplary embodiments of the present disclosure made with reference to the drawings.

### BRIEF DESCRIPTION OF THE DRAWINGS

In order to more clearly illustrate the technical solutions in the embodiments of the present disclosure or in the prior art, the drawings to be used in the description of the embodiments or the prior art will be briefly introduced below. Obviously, the drawings involved in the following description only illustrate some embodiments of the present disclosure, and those skilled in the art can obtain other drawings from these drawings without paying any inventive effort.

FIG. 1 illustrates a cross-sectional view of a connector assembly according to an embodiment of the present disclosure;

FIG. 2 illustrates a semi-sectional perspective view of an outer conductor according to an embodiment of the present disclosure;

FIG. 3 illustrates a schematic diagram of an insulator formed with an annular groove according to an embodiment of the present disclosure;

FIG. 4 illustrates a schematic diagram of an insulator formed with a groove according to an embodiment of the present disclosure;

FIG. 5 illustrates a schematic diagram of a combination of an insulator and a metal ring according to an embodiment of the present disclosure;

FIG. 6 illustrates a schematic diagram of a combination of a U-shaped plate and an insulator according to an embodiment of the present disclosure; and

FIG. 7 illustrates a schematic diagram of a combination of an insulator and a metal ring made by pressing a U-shaped plate in FIG. 6 according to an embodiment of the present disclosure.

### DESCRIPTION OF THE EMBODIMENTS

Various exemplary embodiments of the present disclosure will now be described in detail with reference to the drawings. It should be noted that relative arrangements, numerical expressions and numerical values of components and steps set forth in these embodiments do not limit the scope of the present disclosure unless otherwise specified.

The following description of at least one exemplary embodiment is merely illustrative in nature, and is in no way intended to limit the present disclosure and its application or use.

Techniques, methods and devices known to those of ordinary skills in the art may not be discussed in detail, but in appropriate cases, the above techniques, methods and devices should be regarded as a part of the specification.

In all examples illustrated and discussed here, any specific value should be interpreted as exemplary only rather than a limitation. Therefore, other examples of the exemplary embodiments may have different values.

The technical solutions in the embodiments of the present disclosure will be described clearly and completely with reference to the drawings.

The present disclosure discloses a connector assembly, as illustrated in FIGS. 1 to 7, including an inner conductor 1, an insulator 2, an outer conductor 3 and a metal ring 4, and the outer conductor 3 is disposed around the inner conductor 1, the insulator 2 is disposed between the inner conductor 1 and the outer conductor 3, and the metal ring 4 is disposed around at least a portion of an outer periphery of the insulator 2 and is electrically connected to the outer conductor 3. The metal ring 4 is introduced between the outer conductor 3 and the insulator 2 and the metal ring 4 is electrically connected to the outer conductor 3, so that an internal impedance within the connector can be adjusted using the metal ring 4, without making excessive steps and diameter changes inside the outer conductor 3, and the universality of the outer conductor 3 is realized. Dimensions such as a thickness, a length, etc. of the metal ring 4 are changed according to the specific implementation situation, and the insulator 2 is correspondingly adjusted to be matched and mounted with the metal ring 4, so that the internal impedance of the connector assembly can be adjusted, which reduces the process difficulty and the die manufacturing complexity and is beneficial to reducing the cost.

In some embodiment, a maximum diameter of the metal ring 4 is great than or equal to a maximum diameter of the insulator 2. The metal ring 4 is fixed on the outer periphery of the insulator 2, and the maximum diameter of the metal ring 4 should be greater than or equal to the maximum diameter of the insulator 2, so as to ensure that the metal ring 4 is capable of being in contact with an inner wall of the outer conductor 3 and electrically connected to the outer conductor 3.

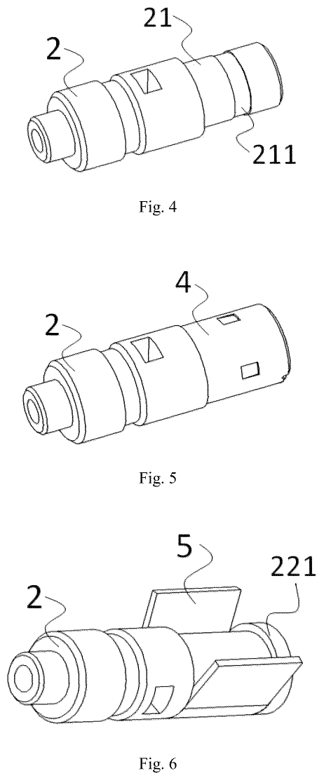

In some embodiments, a recess 21 is disposed on the outer periphery of the insulator 2, and the metal ring 4 is disposed within a space formed between the recess 21 and the inner wall of the outer conductor 3. As illustrated in FIG. 4, when the recess 21 is disposed on the outer periphery of the insulator 2, and the metal ring 4 is disposed within the space formed between the recess 21 and the inner wall of the outer conductor 3, the volume of a Radio Frequency (RF) connector will not be increased due to the introduction of the metal ring 4, and the metal ring 4 being electrically connected to the outer conductor 3 can be ensured, thereby adjusting the internal impedance of the connector.

In some embodiments, the recess 21 is provided with at least one groove 211, and a sidewall of the metal ring 4 is provided with at least one inwardly protruding locking tab, which is engaged in the groove 211 to restrict the metal ring 4 from disengaging from the insulator 2. In order to ensure the position of the metal ring 4 inside the RF connector, the recess 21 on the outer periphery of the insulator 2 is provided with at least one groove 211, and correspondingly, the sidewall of the metal ring 4 is provided with at least one inwardly protruding locking tab, which is engaged in the groove 211 to restrict the metal ring 4 from disengaging from the insulator 2. When the sidewall of the metal ring 4 is provided with a plurality of locking tabs, the recess 21 is correspondingly provided with a plurality of grooves 211 fitted with the plurality of locking tabs to ensure the connection stability between the metal ring 4 and the insulator 2.

In some embodiments, the sidewall of the metal ring 4 is provided with at least one inwardly protruding locking tab, the metal ring 4 and the insulator 2 are integrally formed by injection molding, and at least a portion of the locking tab is injection molded inside the recess 21. In some cases, when the sidewall of the metal ring 4 is provided with at least one inwardly protruding locking tab, and the metal ring 4 and the insulator 2 are integrally formed by injection molding, at least a portion of the locking tab is injection molded inside the recess 21 to limit the metal ring 4 from disengaging from the insulator 2.

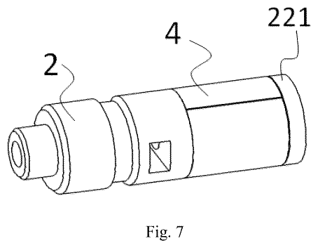

In some embodiments, the outer periphery of the insulator 2 is formed with an annular groove 22, two sides of which are provided with steps 221, the metal ring 4 is sleeved within the annular groove 22, and ends of the metal ring 4 abut against the steps 221. The outer periphery of the insulator 2 is formed with the annular groove 22, the two sides of which are provided with the steps 221, and the metal ring 4 is sleeved within the annular groove 22, in some cases, as illustrated in FIGS. 6 and 7, a plate is stamped into a U-shaped structure and assembled into the annular groove 22, then the U-shaped structure is pressed so that two ends thereof are in contact to form the annular metal ring 4, and ends of the metal ring 4 abut against the steps 221 at the two ends of the annular groove 22.

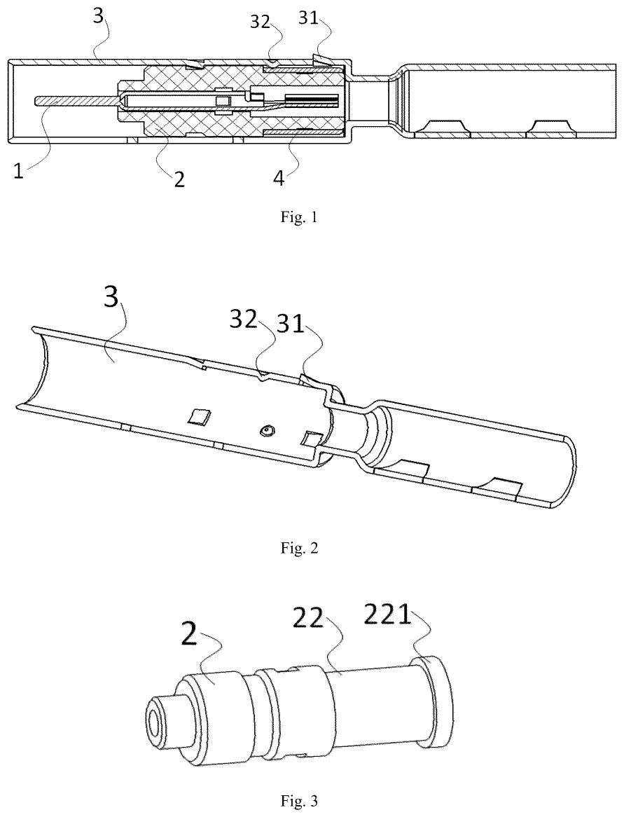

In some embodiments, the outer conductor 3 is a tubular body formed by stamping and bending a plate, and at least one outwardly protruding fixing portion 31 is disposed on an outer periphery of the tubular body, the metal ring 4 is positioned internally at least at the location corresponding to the fixing portion 31 of the outer conductor, and a length of the metal ring 4 in an axial direction of the outer conductor 3 is greater than a length of the fixing portion 31 in the axial direction projected on an outer peripheral surface of the outer conductor 3. As illustrated in FIGS. 1 and 2, the outer conductor 3 is a tubular body formed by stamping and bending a plate, and an outer periphery of the tubular body includes at least one outwardly protruding fixing portion 31 for connection with a connector housing. Stamping the fixing portion 31 may cause the tubular body not to be in a closed state, thereby reducing the shielding effectiveness of the outer conductor 3 and failing to achieve the set function. At least a portion of the metal ring 4 is positioned at the location corresponding to the fixing portion 31 inside the outer conductor 3, and the length of the metal ring 4 in the axial direction of the outer conductor 3 is greater than a projection length of the fixing portion 31 in the axial direction of the outer conductor 3, so that an opening of the fixing portion 31 can be closed inside the outer conductor 3, the shielding performance of the outer conductor 3 can be realized, the impedance inside the outer conductor 3 can by adjusted by the metal ring 4, and it is unnecessary to machine structures such as steps, diameter changes, etc. inside the outer conductor 3.

In some embodiments, the outer conductor 3 is internally provided with at least one inwardly protruding contact portion 32, a deepest point of the contact portion (e.g., a deepest point protruding inward) is electrically connected to an outer surface of the metal ring 4. In order to ensure the electrical connection between the outer conductor 3 and the metal ring 4 so that the metal ring 4 is capable of adjusting the internal impedance of the connector, as illustrated in FIGS. 1 and 2, the outer conductor 3 is internally provided with at least one inwardly protruding contact portion 32, a deepest point of the contact portion is electrically connected to an outer surface of the metal ring 4.

In some embodiments, the outer surface of the metal ring 4 is provided with at least one inwardly recessed limiting portion, and the contact portion is fitted and locked with the limiting portion and electrically connected thereto. In some cases, the outer surface of the metal ring 4 is provided with at least one inwardly recessed limiting portion, and the position of the limiting portion is corresponding to the contact portion 32 on the outer conductor 3. Through the fitting and the locking between the contact portion 32 and the limiting portion, a contact area between the contact portion 32 and the metal ring 4 is increased, and the electrical connection stability between the outer conductor 3 and the metal ring 4 is ensured.

The present disclosure further discloses a Radio Frequency (RF) connector, including a connector housing and the aforementioned connector assembly, and at least a portion of the connector assembly is disposed in the connector housing, the connector housing is internally provided with a locking groove, and a fixing portion 31 is matched with and connected to the locking groove to fix the connector assembly in the connector housing. The RF connector of the present disclosure includes the aforementioned connector assembly and a connector housing, and an inner wall of the connector housing is provided with a locking groove, and a fixing portion 31 on the outer conductor 3 is matched with and connected to the locking groove to fix the connector assembly in the connector housing, so that the RF connector maintains a stable impedance when connected to a mating cable.

Although some specific embodiments of the present disclosure have been described in detail through examples, those skilled in the art should understand that the above examples are only for illustration and are not intended to limit the scope of the present disclosure. Those skilled in the art should understand that the above embodiments can be modified without departing from the scope and the spirit of the present disclosure, and the scope of the present disclosure is defined by the appended claims.

1. A connector assembly, comprising: an inner conductor, an insulator, an outer conductor and a metal ring, wherein the outer conductor is disposed around the inner conductor, the insulator is disposed between the inner conductor and the outer conductor, and the metal ring is disposed around at least a portion of an outer periphery of the insulator and is electrically connected to the outer conductor.

2. The connector assembly according to claim 1, wherein a maximum diameter of the metal ring is greater than or equal to a maximum diameter of the insulator.

3. The connector assembly according to claim 1, wherein the outer periphery of the insulator is provided with a recess, and the metal ring is disposed within a space formed between the recess and an inner wall of the outer conductor.

4. The connector assembly according to claim 3, wherein the recess is provided with at least one groove, and a sidewall of the metal ring is provided with at least one inwardly protruding locking tab, which is engaged in the groove to restrict the metal ring from disengaging from the insulator.

5. The connector assembly according to claim 3, wherein a sidewall of the metal ring is provided with at least one inwardly protruding locking tab, the metal ring and the insulator are integrally formed by injection molding, and at least a portion of the locking tab is injection molded inside the recess.

6. The connector assembly according to claim 1, wherein the outer periphery of the insulator is formed with an annular groove, two sides of which are provided with steps, the metal ring is sleeved within the annular groove, and ends of the metal ring abut against the steps.

7. The connector assembly according to claim 1, wherein the outer conductor is a tubular body formed by stamping and bending a plate, and at least one outwardly protruding fixing portion is disposed on an outer periphery of the tubular body, the metal ring is positioned internally at least at the location corresponding to the fixing portion, and a length of the metal ring in an axial direction of the outer conductor is greater than a length of the fixing portion in the axial direction projected on an outer peripheral surface of the outer conductor.

8. The connector assembly according to claim 1, wherein the outer conductor is internally provided with at least one inwardly protruding contact portion, a deepest point of the contact portion is electrically connected to an outer surface of the metal ring.

9. The connector assembly according to claim 8, wherein the outer surface of the metal ring is provided with at least one inwardly recessed limiting portion, and the contact portion is fitted and locked with the limiting portion and electrically connected thereto.

10. A Radio Frequency connector, comprising a connector housing and a connector assembly, wherein at least a portion of the connector assembly is disposed in the connector housing, the connector housing is internally provided with a locking groove, and a fixing portion is matched with and connected to the locking groove to fix the connector assembly in the connector housing, wherein the connector assembly comprises: an inner conductor, an insulator, an outer conductor and a metal ring, wherein the outer conductor is disposed around the inner conductor, the insulator is disposed between the inner conductor and the outer conductor, and the metal ring is disposed around at least a portion of an outer periphery of the insulator and is electrically connected to the outer conductor.

11. The Radio Frequency according to claim 10, wherein a maximum diameter of the metal ring is greater than or equal to a maximum diameter of the insulator.

12. The Radio Frequency according to claim 10, wherein the outer periphery of the insulator is provided with a recess, and the metal ring is disposed within a space formed between the recess and an inner wall of the outer conductor.

13. The Radio Frequency according to claim 12, wherein the recess is provided with at least one groove, and a sidewall of the metal ring is provided with at least one inwardly protruding locking tab, which is engaged in the groove to restrict the metal ring from disengaging from the insulator.

14. The Radio Frequency according to claim 12, wherein a sidewall of the metal ring is provided with at least one inwardly protruding locking tab, the metal ring and the insulator are integrally formed by injection molding, and at least a portion of the locking tab is injection molded inside the recess.

15. The Radio Frequency according to claim 10, wherein the outer periphery of the insulator is formed with an annular groove, two sides of which are provided with steps, the metal ring is sleeved within the annular groove, and ends of the metal ring abut against the steps.

16. The Radio Frequency according to claim 10, wherein the outer conductor is a tubular body formed by stamping and bending a plate, and at least one outwardly protruding fixing portion is disposed on an outer periphery of the tubular body, the metal ring is positioned internally at least at the location corresponding to the fixing portion, and a length of the metal ring in an axial direction of the outer conductor is greater than a length of the fixing portion in the axial direction projected on an outer peripheral surface of the outer conductor.

17. The Radio Frequency according to claim 10, wherein the outer conductor is internally provided with at least one inwardly protruding contact portion, a deepest point of the contact portion is electrically connected to an outer surface of the metal ring.

18. The Radio Frequency according to claim 17, wherein the outer surface of the metal ring is provided with at least one inwardly recessed limiting portion, and the contact portion is fitted and locked with the limiting portion and electrically connected thereto.
